(19) United States
(12) Patent Application Publication
(10) Pub. No.: US 2022/0161695 A1
(43) Pub. Date: May 26, 2022

(54) VEHICLE SEAT

(71) Applicant: ADIENT ENGINEERING AND IP GMBH, BURSCHEID (DE)

(72) Inventors: Michal Ando, Trencin (SK); Murat Cevik, Koeln (DE); Pinto Thomas Chirayath, Leichlingen (DE); Marco Pruefer, Lindlar (DE); Antonios Simeonidis, Wuppertal (DE)

(73) Assignee: ADIENT ENGINEERING AND IP GMBH, BURSCHEID (DE)

(21) Appl. No.: 17/602,381

(22) PCT Filed: Mar. 30, 2020
(86) PCT No.: PCT/EP2020/058888

§ 371 Date: Oct. 8, 2021

(30) Foreign Application Priority Data
Apr. 8, 2019 (DE) 10 2019 109 214.0
Aug. 20, 2019 (DE) 10 2019 122 310.5

(51) Int. Cl. B60N 2/16

(52) U.S. Cl. CPC B60N 2/165; B60N 2002/0236; B60N 2/1615

(57) ABSTRACT

A vehicle seat may have height-adjustment kinematics where the kinematics may have a four-joint arrangement and an adjustment arm. The four-joint arrangements may have a base, a side part, a front swing arm and a rear swing arm as transmission elements of the four-joint arrangement. A first revolute joint may connect the base in a pivotable manner to the rear swing arm, a second revolute joint may connect the rear swing arm in a pivotable manner to the side part, a third revolute joint may connect the side part in a pivotable manner to the front swing arm, and a fourth revolute joint may connect the front swing arm in a pivotable manner to the base. Each of the two four-joint arrangements can be adjusted by one of the two adjustment arms, and a drive device, having exactly one transmission motor, drives the two adjustment arms.

The invention relates to a vehicle seat having height adjustment kinematics having, on each of two seat sides arranged offset with respect to each other in a transverse direction, in each case a four-joint arrangement and an adjustment arm, each of the two four-joint arrangements in each case having a base, a side part, a front link and a rear link as transmission members of the four-joint arrangement, wherein a first rotary joint connects the base pivotably to the rear link, a second rotary joint connects the rear link pivotably to the side part, a third rotary joint connects the side part pivotably to the front link, and a fourth rotary joint connects the front link pivotably to the base, wherein each of the two four-joint arrangements is in each case adjustable by one of the two adjustment arms.

### PRIOR ART

DE 100 42 851 A1 discloses a height adjustable underframe of a vehicle seat having a left and a right pair of rails of a longitudinal adjustment device and having a left and having a right side part which are each connected in an articulated manner to the associated seat rail of the pair of rails via a rear and a front link, wherein an adjustment arm is provided which is coupled by a lower end region to the associated seat rail at a point of articulation of a rear link and which is secured releasably in the vicinity of its upper end in a locking device which is fastened to the associated side part.

WO 2014/114585 A1 discloses a height adjuster for a vehicle seat, comprising at least one link which is pivotable about a coupling point relative to a side part, and an adjustment arm which has a toothed part and is pivotable about a bearing point, and also a pinion which is rotatable about an axis of rotation and interacts with the toothed part for the height adjustment. The toothed part is formed in an elongated hole of the adjustment arm that faces away from the coupling point of the link.

DE 10 2017 206 994 A1 discloses a vehicle seat, having a drive device for driving height adjustment kinematics of the vehicle seat, an adjustment arm for actuating the height adjustment kinematics, and a tensioning device, the drive device having a pinion which is rotatable about a pinion axis of rotation and is in toothed engagement with a toothed segment of the adjustment arm, wherein the tensioning device pretensions the adjustment arm in such a manner that the toothed segment is pretensioned in the direction of the pinion.

DE 10 2015 212 823 B3 discloses a geared motor having an electric motor and a reduction gearing, wherein the reduction gearing has a transmission housing and an output shaft which projects out of the transmission housing and to the one end of which an output pinion is connected non-rotatably, in particular for driving height adjustment kinematics for a vehicle seat.

### Problem

The invention is based on the problem of improving a vehicle seat of the type mentioned at the beginning, in particular of reducing costs and weight.

### Solution

This problem is solved according to the invention by a vehicle seat having height adjustment kinematics having, on each of two seat sides arranged offset with respect to each other in a transverse direction, in each case a four-joint arrangement and an adjustment arm, each of the two four-joint arrangements in each case having a base, a side part, a front link and a rear link as transmission members of the four-joint arrangement, wherein a first rotary joint connects the base pivotably to the rear link, a second rotary joint connects the rear link pivotably to the side part, a third rotary joint connects the side part pivotably to the front link, and a fourth rotary joint connects the front link pivotably to the base, wherein each of the two four-joint arrangements is in each case adjustable by one of the two adjustment arms, wherein a drive device having precisely one geared motor, drives the two adjustment arms.

Owing to the fact that a drive device having precisely one geared motor drives the two adjustment arms, a height adjustable vehicle seat having adjustment arms arranged on both sides is provided, the vehicle seat requiring only one drive motor.

Advantageous refinements which can be used individually or in combination with one another are the subject matter of the dependent claims.

Each of the two adjustment arms can, on the one hand, be connected pivotably to one of the coupling members of the associated four-joint arrangement, in particular to the respectively assigned rear link. On the other hand, each of the two adjustment arms can in each case have one toothed segment which is in toothed engagement with in each case one pinion of two pinions of the drive device. The two pinions are preferably drivable rotatably about a pinion axis of rotation by the geared motor. The pinion axis of rotation is preferably arranged in a fixed position and with respect to a further transmission member of the four-joint arrangement, in particular with respect to the side part.

The geared motor can be arranged closer to one of the two seat sides than to the other of the two seat sides. The geared motor can be arranged on one of the two seat sides. The geared motor can be connected fixedly to one side part. The geared motor can be connected fixedly to a drive housing.

The drive housing can have a housing plate. The drive housing can support one of the two pinions. One of the two pinions can be fastened to a first end of an output shaft of the geared motor. A transmission tube for transmitting a torque from the geared motor to the other of the two pinions can be connected non-rotatably to a second end of the output shaft. One of the two pinions can be arranged in a first drive housing. The other of the two pinions can be arranged in a second drive housing. One of the two pinions can be mounted in the first drive housing. The other of the two pinions can be mounted in the second drive housing.

The first drive housing and/or the second drive housing can have a housing plate. The housing plate can be fastened at a distance from a side part to the side part in particular by a plurality of bolts, for example screws.

One of the two adjustment arms, in particular a toothed segment of said adjustment arm, can at least partially run through the first drive housing, and/or the other of the two adjustment arms, in particular a toothed segment of said adjustment arm, can at least partially run through the second drive housing.

At least one of the two front links can be at least partially arranged in one of the two drive housings. A side part can be part of the drive housing. A front link can be arranged between a housing plate and a side part. An adjustment arm can be arranged between a housing plate and a side part. As a result, the front link and the adjustment arm between the housing plate and the side part cannot buckle in the event of a crash.

One of the two front links can have an elongated hole in which a pin, in particular a pin of the pinion, is arranged, wherein the pin and the elongated hole form an end stop for the height adjustment kinematics. An end stop on the adjustment arms can thereby be omitted.

At least one of the two rear links can have an elongated hole in which a stop bolt is arranged. The stop bolt is preferably fastened to the base, in particular fastened to an adapter of the base. The stop bolt and the elongated hole can form an end stop for the height adjustment kinematics.

The drive device can be a manual drive device. The drive device can have a manually drivable pinion which is toothed engagement with the toothed segment. Such a drive device is known, for example, from DE 10 2009 014 651 A1.

The drive device can be an electrified drive device, wherein the pinion is part of an electromotive drive device as is known, for example, from DE 197 09 852 A1.

Rotation of the two pinions about a common pinion axis of rotation causes a relative movement between the pinions and the adjustment arms. In particular, the rotation of the pinion about the pinion axis of rotation causes a relative movement between the adjustment arms and a further component of the vehicle seat, on which the drive device is arranged, in particular a seat frame.

Preferably in addition to driving the four-joint arrangement, the adjustment arms preferably bring about blocking of the four-joint arrangement in a non-driven state. For this purpose, the drive device is preferably configured to be self-locking such that the pinion cannot be rotated when the electric motor is switched off (in the case of an electrified drive device) or when an actuating lever remains unactuated (in the case of a manual drive device).

A region of the adjustment arm facing away from the toothed segment is preferably coupled to one of the coupling members eccentrically with respect to the rotary joints, wherein the drive device is coupled to another of the coupling members. That region of the adjustment arm which faces away from the toothed segment can be coupled to the rear link. The drive device and the tensioning device can be fastened to the side part.

In summary and expressed in other words, the invention provides a height adjuster seat frame with rack segments and only one drive motor and a sandwich arrangement of a link and of the rack segment. A height adjustment of the seat frame with one rack on each side, but with only one drive motor and a transmission rod to the opposite rack drive is provided. Furthermore, a sandwich construction enables end stops to be integrated in the front and/or rear links. Two interfaces are located on the drive motor, one interface (gear wheel) directly drives the rack. The second interface on the drive motor is characterized by a multi-toothed drive, as a result of which the torque is transmitted by a tube to the second pinion/the second rack on the opposite side. The arrangement of the front and rear links permits a space-saving construction with integrated end stops.

The invention is explained in more detail below with reference to an advantageous exemplary embodiment illustrated in the figures. However, the invention is not restricted to this exemplary embodiment. In the figures:

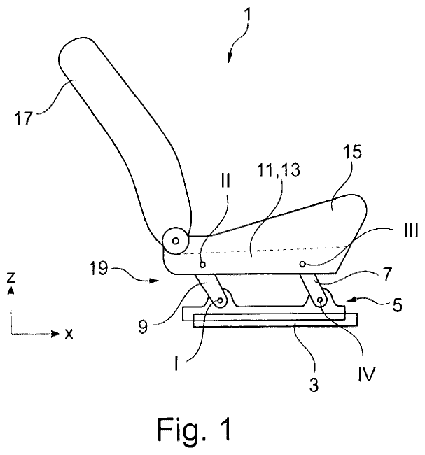

FIG. 1: shows a schematized side view of a vehicle seat according to the invention,

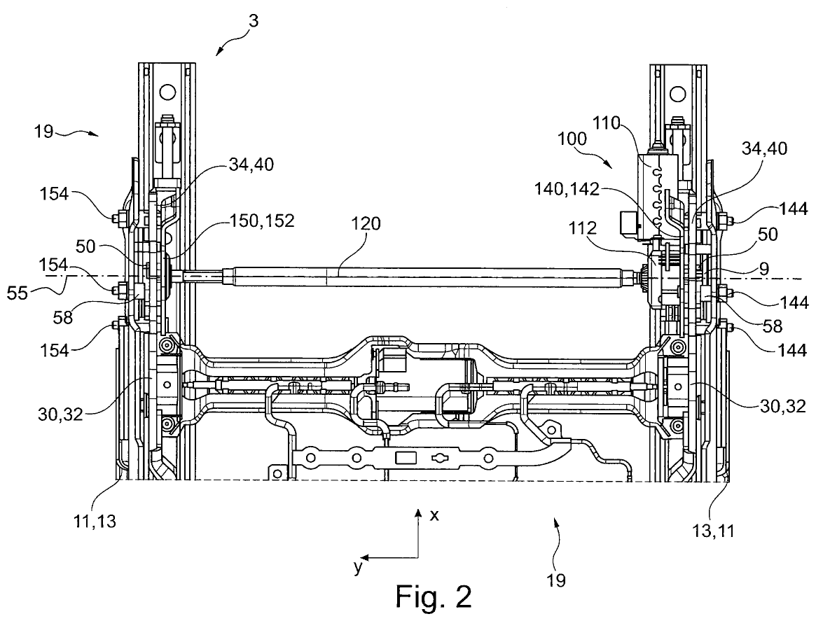

FIG. 2: shows part of a top view of a seat base of the vehicle seat according to the invention,

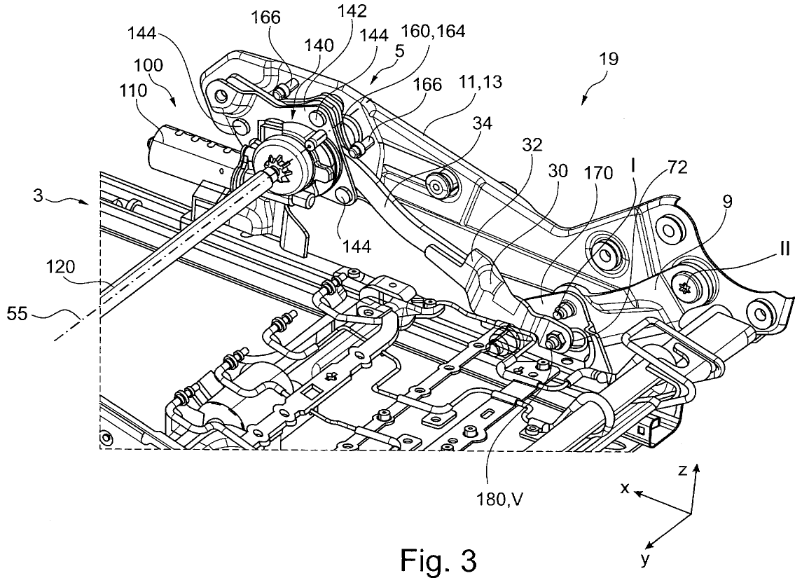

FIG. 3: shows part of a perspective view of the seat base of the vehicle seat according to the invention,

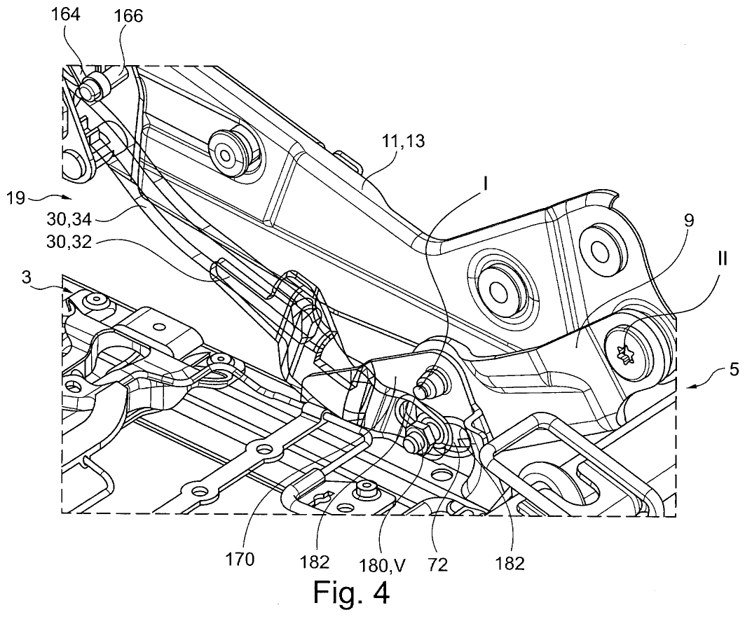

FIG. 4: shows an enlarged and partially transparent detail from FIG. 3,

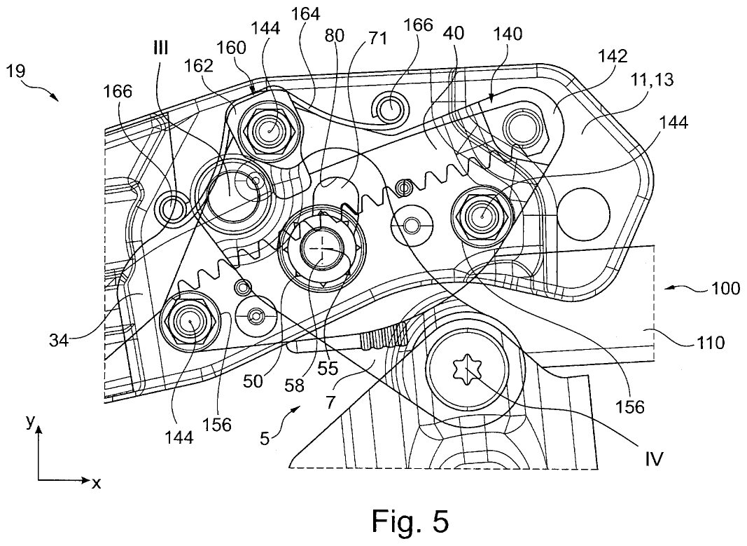

FIG. 5: shows a partially transparent side view of a detail of a front region of the seat base, and

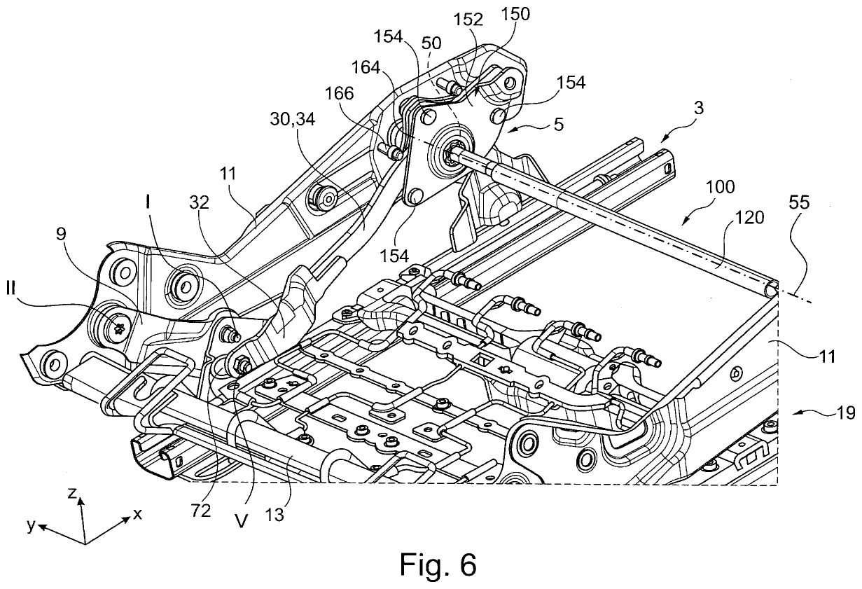

FIG. 6: shows part of a perspective view of the seat base of the vehicle seat according to the invention from a viewing direction differing from FIG. 3.

A vehicle seat 1 which is illustrated schematically in FIG. 1 will be described below using three spatial directions running perpendicularly to one another. With a vehicle seat 1 installed in the vehicle, a longitudinal direction x runs substantially horizontally and preferably parallel to a vehicle longitudinal direction which corresponds to the customary direction of travel of the vehicle. A transverse direction y running perpendicularly to the longitudinal direction x is likewise oriented horizontally in the vehicle and runs parallel to a vehicle transverse direction. A vertical direction z runs perpendicularly to the longitudinal direction x and perpendicularly to the transverse direction y. With a vehicle seat 1 installed in the vehicle, the vertical direction z runs parallel to the vehicle vertical axis.

The position specifications and direction specifications used, such as, for example, front, rear, top and bottom, relate to a viewing direction of an occupant seated in the vehicle seat 1 in a normal seat position, with the vehicle seat 1 being installed in the vehicle and being oriented in a use position suitable for passenger transport, with an upright backrest 17 and in the direction of travel, as customary. However, the vehicle seat 1 according to the invention may also be installed in a different orientation, for example transversely with respect to the direction of travel. Unless described otherwise, the vehicle seat 1 is constructed in a mirror-symmetrical manner with respect to a plane running perpendicularly to the transverse direction y.

The vehicle seat 1 is height adjustable, that is to say a distance in the vertical direction z between a seat surface of the vehicle seat 1 and a vehicle floor can be adjusted, in particular in order to adapt the vehicle seat 1 to the height of an occupant. The vehicle seat 1 is fastenable with a base 3, for example two pairs of seat rails, to the vehicle floor of the motor vehicle. Height adjustment kinematics 5 of the vehicle seat 1 have a respective four-joint arrangement (I, II, III, IV) on both seat sides, as viewed in the transverse direction y, said four-joint arrangement in each case being formed from the base 3, a front link 7, a rear link 9 and a side part 11 of a seat frame 13 that are each connected to one another by rotary joints I, II, III, IV. On both sides, a respective first rotary joint I connects the base 3 pivotably to the respective rear link 9. On both seat sides, a respective second rotary joint II connects the respective rear link 9 pivotably to the respective side part 11. On both seat sides, a respective third rotary joint III connects the side part 11 pivotably to the respective front link 7. On both seat sides, a respective fourth rotary joint IV connects the respective front link 7 pivotably to the base 3. The seat frame 13 comprises a respective side part 11, in the present case a seat frame side part, on both seat sides in a manner known per se. The rotary joints I, II, III, IV each permit a rotational movement about a respective axis parallel to the transverse direction y.

The vehicle seat 1 comprises a seat structure and a plurality of cushion parts carried by the seat structure, the cushion parts comprising foam parts and cushion covers, in particular made from fabric or leather. The backrest 17 has in particular a backrest structure. The backrest 17 is fastened pivotably to a seat base 19 by two fittings, not illustrated in the figures. The seat base 19 has in particular a seat base structure. The backrest structure and the seat base structure substantially form the seat structure. The seat base structure comprises the base 3, the height adjustment kinematics 5 and the seat frame 13.

The height of the seat cushion 15 and, in the present case, at the same time of the backrest 17 of the vehicle seat 1 above the vehicle floor (and therefore above the base 3) is adjustable by the height adjustment kinematics 5.

In order to drive and to block the height adjustment kinematics 5, an adjustment arm 30 which is effective between the respective rear link 9 and the respective side part 11 is arranged in each case on the two seat sides. The adjustment arms 30 act kinematically in each case as a length-changeable coupling between the associated rear link 9 and the respective side part 11. A respective first end of the adjustment arms 30 is coupled to the associated rear link 9 in a respective fifth rotary joint V eccentrically with respect to the first rotary joint I of the four-joint arrangement (I, II, III, IV). A respective second end of the adjustment arms 30 has a toothed segment 40. The toothed segments 40 are in each case designed in the manner of a curved rack. The adjustment arms 30 in the present case both consist of a respective first arm part 32 and a second arm part 34 connected fixedly to the first arm part 32. The toothed segment 40 of the respective adjustment arm 30 is formed on the respective second arm part 34.

The effective length of the adjustment arm 30 determines the adjustment of the associated four-joint arrangement (I, II, III, IV) and thus the distance in the vertical direction z between the seat surface of the vehicle seat 1 and the vehicle floor. A change in the effective length of the adjustment arms 30 thus actuates the height adjustment kinematics 5.

The effective length of the adjustment arms 30 can be changed by in each case one toothed segment 40 being in toothed engagement with in each case one of two pinions 50 of a drive device 100 fastened to the seat frame 13. A rotation of the pinions 50 brings about a displacement of the toothed segments 40 relative to the respectively assigned pinion 50 and thus relative to the seat frame 13, as a result of which the (kinematically) effective length of the adjustment arm 30 changes.

In modifications of the exemplary embodiment, the adjustment arm 30 can also be an integral, rectilinear or curved rack.

The drive device 100 has precisely one electric geared motor 110 which drives the two pinions 50 which are mounted rotatably about a common pinion axis of rotation 55. The pinion axis of rotation 55 runs parallel to the transverse direction y. The drive device 100 corresponds, for example, to a drive device known from DE 197 09 852 A1. The geared motor 110 is fastened, in particular screwed, to a first drive housing 140. The first drive housing 140 is fastened to one of the two side parts 11 of the seat frame 30, preferably screwed to one of the two side parts 11 by a plurality of screws.

The first drive housing 140 has a first housing plate 142 which is fastened to the seat part 11 at a distance therefrom by three bolts 144 designed in the present case as stepped bolts. The adjustment arm 30 assigned to the first drive housing 140 is arranged movably in the transverse direction y between the first housing plate 142 and the side part 11 to which the first drive housing 140 is fastened.

The geared motor 110 is configured to be self-locking, and therefore, in an unenergized state of the electric motor (of the geared motor 110), the pinions 50 cannot be rotated via the toothed segments 40 and therefore the height adjustment kinematics 5 are blocked.

In a modification of the exemplary embodiment, the pinions 50 are part of a mechanical drive device, as known, for example, from DE 10 2009 014 651 A1.

If the drive device 100 is driven, the latter pivots the two adjustment arms 30, the side parts 11 and the rear links 9 relative to one another such that the height adjustment kinematics 5 are actuated.

The geared motor 110 has an output shaft which is aligned with the pinion axis of rotation 55 and protrudes on both sides from a transmission housing 112. On one side, the same pinion 50 which is in toothed engagement with the associated toothed segment 40 on the seat side on which the geared motor 110 is screwed to one of the two side parts 11 is fastened to the output shaft.

On the other side, the output shaft of the geared motor 110 has an encircling external toothing onto which a complementary internal toothing of a transmission tube 120 is plugged.

On the seat side facing away from the geared motor 110, the transmission tube 120 is connected non-rotatably to the other of the two pinions 50. On the seat side facing away from the geared motor 110, the pinion 50 is mounted in a second drive housing 150.

The second drive housing 150 has a second housing plate 152 which is fastened to the side part 11 at a distance therefrom by three bolts 154 designed in the present case as stepped bolts. The adjustment arm 30 assigned to the second drive housing 150 is arranged movably in the transverse direction y between the second housing plate 152 and the side part 11 to which the second drive housing 150 is fastened.

The two drive housings 140, 150 each have a pretensioning unit 160 having a slider 162 and a mechanical force store, in the present case a spring 164. The spring 164 is supported on one side on the slider 162 and on the other side on a supporting pin 166 connected to the side part 11. The slider 162 has an opening which receives one of the bolts 144, 154. The slider 162 is thereby mounted on said bolt 144, 154 so as to be displaceable to a limited extent. The spring 164 tensions the slider 162 on a side of the toothed segment 40 facing away from the pinion 50 against the toothed segment 40 in such a manner that free play is produced between the toothings of pinion 50 and toothed segment 40 that are in toothed engagement.

Each of the two front links 7 has a first elongated hole 71 which is curved about the third rotary joint III. In each case one pin 58 aligned with the two pinions 50 with the pinion axis of rotation 55 engages in the associated first elongated hole 71. The length of the first elongated hole 71 is configured in such a manner that, in an uppermost adjustment position of the height adjustment kinematics 5, the pin 58 runs up to a first end of the first elongated hole 71 and, in a lowermost adjustment position of the height adjustment kinematics 5, runs up to a second end of the first elongated hole 71. As a result, the pins 58 and the first elongated holes 71 receiving the pins 58 form first end stops 80 of the height adjustment kinematics 5.

In addition, in the uppermost adjustment position of the height adjustment kinematics 5 and in the lowermost adjustment position of the height adjustment kinematics 5, each of the two front links 7 in each case runs up to one of the bolts 144, 154. As a result, each of the two front links 7 together with the bolts 144, 154 forms second end stops 156 of the height adjustment kinematics 5. The second end stops 156 of the height adjustment kinematics 5 can act parallel to the first end stops 80 of the height adjustment kinematics 5. Preferably, however, during normal use of the vehicle seat 1, only the first end stops 80 or only the second end stops 156 are effective. The respective other end stops 80, 156 then pass into a stop position only in the event of a crash following an elastic or plastic deformation of the vehicle seat 1.

The two first rotary joints I are each formed on an adapter 170 of the base 3. Each of the two adapters 170 has a second elongated hole 72 which is curved about the first rotary joint I. In each case one stop bolt 180 fastened to the rear link 9 engages in the associated second elongated hole 72. The length of the second elongated hole 72 is configured in such a manner that, in an uppermost adjustment position of the height adjustment kinematics 5, each of the two stop bolts 180 runs up to a first end of the second elongated hole 72 and, in a lowermost adjustment position of the height adjustment kinematics 5, runs up to a second end of the second elongated hole 72. As a result, the stop bolts 180 and the second elongated holes 72 receiving the stop bolts 180 form third end stops 182 of the height adjustment kinematics 5.

Preferably, however, during normal use of the vehicle seat 1, only the first end stops 80 or only the second end stops 156 or only the third end stops 182 are effective. The respective other end stops 80, 156, 182 then pass into a stop position only in the event of a crash following an elastic or plastic deformation of the vehicle seat 1.

The features disclosed in the above description, the claims and the drawings may be of significance both individually and in combination for implementing the invention in its various refinements.

Although the invention has been described in detail in the drawings and the previous illustration, the illustrations should be understood as illustrative and by way of example and nonlimiting. In particular, the selection of the graphically illustrated proportions of the individual elements should not be interpreted as required or restricting. Furthermore, the invention is in particular not restricted to the exemplary embodiments explained. Further variants of the invention and the realization thereof are apparent to a person skilled in the art from the above disclosure, the figures and the claims.

Terms such as “comprise”, “have”, “include”, “contain” and the like used in the claims do not exclude further elements or steps. The use of the indefinite article does not exclude a plurality. An individual device can carry out the functions of a plurality of units or devices mentioned in the claims.

### LIST OF REFERENCE SIGNS

1 Vehicle seat
3 Base
5 Height adjustment kinematics
7 Front link
9 Rear link
11 Side part
13 Seat frame
15 Seat cushion
17 Back rest
19 Seat base
30 Adjustment arm
32 First arm part
34 Second arm part
40 Toothed segment
50 Pinion
55 Pinion axis of rotation
58 Pin
71 (First) elongated hole
72 (Second) elongated hole
80 (First) end stop
100 Drive device
110 Geared motor
112 Transmission housing
120 Transmission tube
140 First drive housing
142 Housing plate
144 Bolt
150 Second drive housing
152 Housing plate
154 Bolt
156 (Second) end stop
160 Pretensioning unit
162 Slider
164 Spring
166 Supporting pin
170 Adapter
180 Stop bolt
182 (Third) end stop
I First rotary joint
II Second rotary joint
III Third rotary joint
IV Fourth rotary joint
V Fifth rotary joint
x Longitudinal direction
y Transverse direction
z Vertical direction

1-15. (canceled)

16. A vehicle seat having height adjustment kinematics having, on each of two seat sides arranged offset with respect to each other in a transverse direction, in each case a four-joint arrangement and an adjustment arm, each of the two four-joint arrangements in each case having a base, a side part, a front link and a rear link as transmission members of the four-joint arrangement, wherein a first rotary joint connects the base pivotably to the rear link, a second rotary joint connects the rear link pivotably to the side part, a third rotary joint connects the side part pivotably to the front link, and a fourth rotary joint connects the front link pivotably to the base, wherein each of the two four-joint arrangements is in each case adjustable by one of the two adjustment arms, wherein a drive device having precisely one geared motor, drives the two adjustment arms.

17. The vehicle seat as claimed in claim 16, wherein each of the two adjustment arms, on the one hand, is in toothed engagement pivotably with one of the coupling members of the four-joint arrangement, and, on the other hand, in each case one toothed segment of each adjustment arm is in toothed engagement with in each case one pinion of two pinions of the drive device, wherein the two pinions are drivable rotatably about a pinion axis of rotation by the geared motor, and the pinion axis of rotation is arranged in a fixed position with respect to a further transmission member of the four-joint arrangement, in particular in a fixed position with respect to the side part.

18. The vehicle seat as claimed in claim 17, wherein each of the two adjustment arms is connected pivotably to the respectively assigned rear link.

19. The vehicle seat as claimed in claim 17, wherein the pinion axis of rotation is arranged in a fixed position with respect to the side parts.

20. The vehicle seat as claimed in claim 16, wherein the geared motor is arranged closer to one of the two seat sides than to the other of the two seat sides.

21. The vehicle seat as claimed in claim 16, wherein one of the two pinions is fastened to a first end of an output shaft of the geared motor, and a transmission tube for transmitting a torque from the geared motor to the other of the two pinions is connected non-rotatably to a second end of the output shaft.

22. The vehicle seat as claimed in claim 16, wherein one of the two pinions is arranged in a first drive housing, and/or the other of the two pinions is arranged in a second drive housing.

23. The vehicle seat as claimed in claim 22, wherein the first drive housing and/or the second drive housing has a housing plate which is fastened at a distance from one of the two side parts to said side part.

24. The vehicle seat as claimed in claim 23, wherein the housing plate is fastened at a distance from one of the two side parts to said side part by a plurality of bolts.

25. The vehicle seat as claimed in claim 22, wherein one of the two adjustment arms, including a toothed segment of said adjustment arm, at least partially runs through the first drive housing, and/or the other of the two adjustment arms, including a toothed segment of said adjustment arm, at least partially runs through the second drive housing.

26. The vehicle seat as claimed in claim 22, wherein at least one of the two front links is at least partially arranged in one of the two drive housings.

27. The vehicle seat as claimed in claim 16, wherein at least one of two front links has an elongated hole in which a pin is arranged, wherein the pin and the elongated hole form an end stop for the height adjustment kinematics.

28. The vehicle seat as claimed in claim 27, wherein a pin of the pinion and the elongated hole form an end stop for the height adjustment kinematics.

29. The vehicle seat as claimed in claim 16, wherein at least one of the two rear links has an elongated hole in which a stop bolt is arranged, wherein the stop bolt and the elongated hole form an end stop for the height adjustment kinematics.

30. The vehicle seat as claimed in claim 29, wherein the stop bolt is fastened to an adapter of the base.
